(19) United States
(12) Patent Application Publication
(10) Pub. No.: US 2008/0058488 A1
(43) Pub. Date: Mar. 6, 2008

(54) HEAT-SHRINKABLE PET FILM AND METHOD FOR MAKING THE SAME

(75) Inventors: Pang-Chin LIU, Taoyuan (TW); Chih-Heng WU, Taoyuan (TW); Cheng-Hsiang CHUNG, Taoyuan (TW); Chih-Wei CHU, Taoyuan (TW); Roy WU, Taoyuan (TW)

Correspondence Address: SHERIDAN ROSS PC, 1560 BROADWAY, SUITE 1200, DENVER, CO, 80202, US

(73) Assignee: FAR EASTERN TEXTILE LTD., Taipei (TW)

(21) Appl. No.: 11/846,732

(22) Filed: Aug. 29, 2007

(30) Foreign Application Priority Data
Sep. 1, 2006 (TW) 095132327

(51) Int. Cl. C08F 2/44

(52) U.S. Cl. 526/210

(57) ABSTRACT

A PET material of a modified PET composition includes: terephthalic acid; ethylene glycol; a modifier; and a chain branching agent selected from one of a non-cyclic compound and a cyclic compound. The non-cyclic compound has at least three functional groups, and the cyclic compound, after ring opening, has at least three functional groups. Each of the functional groups of each of the non-cyclic compound and the cyclic compound is selected from hydroxyl group, carboxyl group, amine group, epoxy group, NCO, and COOR, in which R represents a C₁-C₁₈ alkyl group.

### CROSS-REFERENCE TO RELATED APPLICATION

This application claims priority of Taiwanese application no. 095132327, filed on Sep. 1, 2006.

### BACKGROUND OF THE INVENTION

1. Field of the Invention

This invention relates to a PET material and a method for making the same, more particularly to a PET material made from a composition containing a chain branching agent for enhancing the melt strength thereof.

2. Description of the Related Art

Conventional polyethylene terephthalate (PET) materials are made from a PET composition containing a PET modifier, such as isophthalic acid (IPA), neopentyl glycol (NPG), or 1,4-cyclohexanedimethanol (CHDM). The modified PET material is thermally stretched at a stretching temperature (normally 10 to 15° C. higher than the glass transition temperature (T_{g}) of the modified PET material) and is subsequently cooled so as to obtain a heat-shrinkable PET film that exhibits shape-memory characteristics which permit the heat-shrinkable PET film to be shrunk when heated to a temperature higher than the stretching temperature. The CHDM modified heat-shrinkable PET film can achieve a heat shrinkage ratio of 60% based on the standard of JIS Z1709. However, CHDM and its monomer are relatively expensive. The IPA modified heat-shrinkable PET film can also achieve a heat shrinkage ratio of about 60% based on the standard of JIS Z1709. However, it requires a longer shrinking time and a higher temperature (about 125° C.) to reach the desired heat shrinkage ratio. The NPG modified heat-shrinkable PET film normally has a heat shrinkage ratio of less than 50% based on the standard of JIS Z1709, and requires an additional modifier to enhance the heat shrinkage ratio.

Double-bubble blowing techniques for film stretching have been used to place conventional stretching techniques due to their low capital and operating costs. However, since the conventional PET film has a linear molecular structure and a relatively low molecular weight, it has an insufficient strength for film stretching using double-bubble blowing techniques or double-bubble blown film extrusion techniques.

### SUMMARY OF THE INVENTION

Therefore, the object of the present invention is to provide a PET material that can overcome at least one of the aforesaid drawbacks of the prior art.

Another object of this invention is to provide a method for making the PET material.

According to one aspect of the present invention, a PET material of a modified PET composition is provided. The modified PET composition comprises: terephthalic acid; ethylene glycol; a modifier selected from the group consisting of 1,3-dihydroxy-2-methylpropane, 1,3-dihydroxy-2-methylpropane alkoxylate, 2,5-dimethyl-2,5-hexanediol, and combinations thereof; and a chain branching agent selected from one of a non-cyclic compound and a cyclic compound. The non-cyclic compound has at least three functional groups, and the cyclic compound, after ring opening, has at least three functional groups. Each of the functional groups of each of the non-cyclic compound and the cyclic compound is selected from the group consisting of hydroxyl group, carboxyl group, amine group, epoxy group, NCO, and COOR, in which R represents a C₁-C₁₈ alkyl group.

According to another aspect of the present invention, a method for making a PET material comprises: (a) forming a PET film of a PET material of a modified PET composition that comprises: terephthalic acid; ethylene glycol; a modifier selected from the group consisting of 1,3-dihydroxy-2-methylpropane, 1,3-dihydroxy-2-methylpropane alkoxylate, 2,5-dimethyl-2,5-hexanediol, and combinations thereof; and a chain branching agent selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, and combinations thereof; (b) thermally stretching the PET film in a stretching direction under a temperature ranging from 50° C. to 130° C. such that the ratio of the film thickness of the PET film after stretching to that of the PET film before stretching ranges from 0.2 to 0.95; and (c) cooling the thermally stretched PET film.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a DSC diagram showing a measured nucleation rate of a PET material.

### DETAILED DESCRIPTION OF THE PREFERRED EMBODIMENTS

It is known in the art that certain polymer films, when stretched under a stretching temperature higher than their glass transition temperatures (T_{g}) and lower than their melting points (Tₘ), have a common feature that large molecules of the amorphous region of the polymer film will be extended along the stretching direction. These extended large molecules are ‘frozen’, i.e., being set in shape, when cooled, and exhibit shape-memory characteristics or a heat-shrinkable ability. By virtue of this property, when a heat-shrinkable polymer film is heated to a temperature higher than the stretching temperature, the extended large molecules of the amorphous region of the polymer film begin to shrink along the stretching direction. Hence, it is possible to enhance the shrinking ability of a polymer film by increasing the extent of its amorphous phase, i.e., reducing the extent of its crystalline phase, by adding a modifier into a polymerization system to destroy nucleation and crystallization in the polymerization system. Furthermore, by adding a chain branching agent into the polymerization system to increase the degree of branches of the polymer, the melt strength of the polymer can be considerably enhanced, thereby rendering the polymer suitable for stretching using double-bubble film blowing techniques.

As indicated above, it is desirable to find a modifier which is less expensive and which can result in a shorter shrinking time for the heat-shrinkable PET film, and a chain branching agent which can enhance the strength of the PET film so that the latter can be stretched using double-bubble blowing techniques or double-bubble blown film extrusion techniques.

Accordingly, there is provided a PET material in this invention that can overcome at least one of the aforesaid drawbacks of the prior art. The PET material is made from a modified PET composition that comprises: terephthalic acid; ethylene glycol; a first modifier selected from the group consisting of 1,3-dihydroxy-2-methylpropane, 1,3-dihydroxy-2-methylpropane alkoxylate, 2,5-dimethyl-2,5-hexanediol, and combinations thereof; and a chain branching agent selected from one of a non-cyclic compound and a cyclic compound. The non-cyclic compound has at least three functional groups, and the cyclic compound, after ring opening, has at least three functional groups. Each of the functional groups of each of the non-cyclic compound and the cyclic compound is selected from the group consisting of hydroxyl group, carboxyl group, amine group, epoxy group, NCO, and COOR, in which R represents a C₁-C₁₈ alkyl group.

Preferably, the chain branching agent is selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, and combinations thereof.

Preferably, the modified PET composition contains 0.01 to 2 mole % of the chain branching agent based on one mole of ethylene glycol, and more preferably contains 0.05 to 1 mole % of the chain branching agent based on one mole of ethylene glycol.

Preferably, the PET material has a glass transition temperature ranging from 40° C. to 85° C., more preferably, from 60° C. to 80° C., and most preferably, from 65° C. to 75° C.

Preferably, the PET material has a melting point ranging from 170° C. to 250° C.

Preferably, the PET material is amorphous.

Preferably, the modified PET composition contains 2 to 40 mole % of the first modifier based on one mole of ethylene glycol, and more preferably, contains 12 to 40 mole % of the first modifier based on one mole of ethylene glycol. When the amount of the first modifier is less than 2 mole %, the desired heat-shrinkage ratio cannot be achieved. When the amount of the first modifier is greater than 40 mole %, the raw material cost is considerably increased, and the mechanical strength and thermal resistance are decreased. The applicants found that the PET material has a melting point ranging from 170 to 250° C. when the amount of the first modifier ranges from 2 to 20 mole %, and is amorphous when the amount of the first modifier ranges from 20 to 40 mole %.

The PET material preferably has an intrinsic viscosity ranging from 0.6 to 1.2. When the intrinsic viscosity of the PET material is less than 0.6, the molecular weight of the PET material is too low to be suitable for processing. When the intrinsic viscosity of the PET material is greater than 1.2, stirring of the PET material is difficult, which can result in deterioration in the quality of the product formed from the PET material.

Preferably, the modified PET composition further includes a second modifier selected from the group consisting of a diacid, a diol, and combinations thereof.

The diol of the second modifier is preferably selected from the group consisting of neopentyl glycol, isopentyl diol, polyethylene glycol, bisphenol A alkoxylate, 1,4-cyclohexanedimethanol, and combinations thereof, and is preferably present in an amount ranging from 1 to 40 mole %, and more preferably, from 1 to 30 mole %, based on one mole of ethylene glycol. When the second diol is a mixture of polyethylene glycol, bisphenol A alkoxylate, and 1,4-cyclohexanedimethanol, the PET material thus formed can be enhanced in properties, such as tensile strength, impact strength, and heat-shrinkable ratio.

The diacid of the second modifier is preferably selected from the group consisting of isophthalic acid, sebacid acid, naphthalene dicarboxylic acid, adipic acid, and combinations thereof, and is preferably present in an amount ranging from 1 to 30 mole %, and more preferably, from 2 to 20 mole %, based on one mole of ethylene glycol. When isophthalic acid is used as the second modifier, the amorphous phase region of the PET material can be increased. When adipic acid or sebacid acid is used as the second modifier, flexibility of the PET material thus formed can be increased. When naphthalene dicarboxylic acid is used as the second modifier, the glass transition temperature, the thermal resistance and the impact strength of the PET material thus formed can be increased.

Additives, such as silica, silicon dioxide gel, aluminum oxide, caoline, calcium carbonate, titanium oxide, and barium sulfate, can be added into the modified PET composition.

The method for making a PET film according to this invention includes the steps of: (a) forming the PET film of the PET material of the modified PET composition; (b) thermally stretching the PET film in a stretching direction under a temperature ranging from 50° C. to 130° C. such that the ratio of the film thickness of the PET film after stretching to that of the PET film before stretching ranges from 0.2 to 0.95; and (c) cooling the thermally stretched PET film.

Preferably, the thermally stretched PET film body has a film thickness ranging from 0.01 mm to 0.1 mm.

In this embodiment, thermal stretching of the PET film is conducted by double bubble blown film extrusion techniques and the PET film stretching operation is conducted along two perpendicular directions, i.e., MD and TD directions based on the standard of JIS Z1709.

Preferably, the stretching temperature is 10 to 15° C. higher than the glass transition temperature of the PET material, and the temperature for shrinking the stretched PET film is 10 to 15° C. higher than the stretching temperature. Hence, the stretching temperature for stretching the PET film preferably ranges from 50° C. to 100° C., and more preferably, from 70 to 90° C., and the temperature for shrinking the stretched PET film preferably ranges from 65 to 115° C., and more preferably, from 85 to 100° C.

The heat-shrinkage ratio of the heat-shrinkable PET film of this invention can be adjusted by adjusting the modified PET composition, the stretching extent, and the stretching temperature based on the actual requirements. For instance, according to the standard of JIS Z1709, a heat-shrinkable PET film having: a heat-shrinkage ratio of greater than 30% in one of MD (machine direction) and TD (transverse direction) directions and a heat-shrinkage ratio of less than 10% in the other of the MD and TD directions is suitable for application to shrinkable labels; a heat-shrinkage ratio of greater than 30% in both the MD and TD directions is suitable for application to general containers, batteries, and parts; a heat-shrinkage ratio of greater than 50% in one of the MD and TD directions is suitable for application to particular containers having curved or unusual shapes; and a heat-shrinkage ratio of greater than 50% in both the MD and TD directions is suitable for application to irregular shaped articles.

As mentioned above, the heat-shrinkage ratio of a heat-shrinkable film is mainly affected by the extent of the amorphous region, which can be controlled by addition of a modifier into the polymerization system during polymerization of the PET material. Hence, the higher the crystalline extent, the poorer will be the heat-shrinkage ratio of the heat-shrinkable film. The crystalline extent of a PET material can be determined by measuring a nucleation rate (tan α), and a crystallization rate (G), which will be described in greater detail in the following paragraphs.

### Testing Method:

Determining the Nucleation Rate:

Placing a specimen of a heat-shrinkable PET film to be tested in a Differential Scanning Calorimetry (DSC) Instrument;

Raising a working temperature of the instrument at a rate of 10° C./min. from 30 to 300° C.; and

Lowering immediately the working temperature at a rate of 10° C./min. from 300 to 30° C.

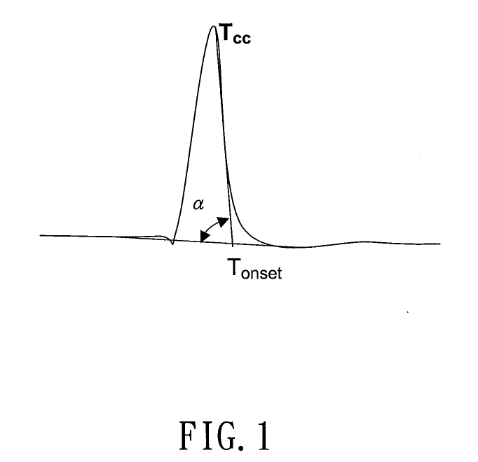

A crystallization peak as illustrated in FIG. 1 is obtained through this DSC analysis. An angle a between the slope (the sharpest slope of the peak) and the baseline is determined. The nucleation rate is represented by tan α. The higher the value of tan α, the higher will be the nucleation rate and the higher will be the extent of the crystalline phase for the heat-shrinkable PET film. T_{cc} represents the crystallization temperature. Tₒₙₛₑₜ represents the temperature at an intersection of the baseline and the slope line.

Determining the Crystallization Rate:

Placing a specimen of a heat-shrinkable PET film to be tested in a Differential Scanning Calorimetry (DSC) Instrument;

Raising a working temperature of the instrument at a rate of 160° C. /min. from 30 to 280° C. under a nitrogen gas flow rate of 50 ml/min.;

Maintaining the working temperature at 280° C. for 5 min.;

Lowering immediately the working temperature at a rate of 160° C./min. from 280° C. to a crystallization temperature; and

Recording and calculating the half time crystallization and crystallization rate using Avrami equation, log{−ln[1−X(t)]}=log(k)+n log(t). X(t) is the crystallization degree at time (t). k is a crystallization constant. N is Avrami index. The half time crystallization (the time to reach 50% crystallization) is represented by t_{1/2}, which is equal to (ln2/k)^{1/n}. The crystallization rate is represented by G, which is equal to 1/t_{1/2}. The higher the value of G, the higher will be the crystallization rate.

The merits of the heat-shrinkable PET film of this invention will become apparent with reference to the following Examples and Comparative Examples.

### EXAMPLES

### Nucleation Rate and Crystallization Rate Experiments

### Example 1

### E1

Terephthalic acid, ethylene glycol, and 1,3-dihydroxy-2-methylpropane (DHMP) (serving as the first modifier) in a mole ratio of 1:1.175:0.075 were uniformly mixed in a container and were formed into a paste. A stabilizer (75 ppm) was added into and blended with the mixture. The paste was fed into an esterification reactor and underwent esterification under a pressure of about 3 kg/cm² for 6 to 7 hours. The reaction temperature reached about 250° C. at the end of the reaction. The mixture was then fed together with a catalyst of a mixture of Sb₂O₃ (300 ppm) and cobalt acetate (50 ppm), into a condensation rector and underwent condensation. The reactor temperature was raised to 285° C. and the reactor was vacuumed to about 1 torr in two hours. The condensation was terminated when the intrinsic viscosity of the reaction product reached a range of from 0.7 to 0.9. The duration of the reaction time was about 4 to 5 hours.

### Example 2

### E2

The reaction conditions of this example were similar to those of Example 1, except that the first modifier was 1,3-dihydroxy-2-methylpropane alkoxylate (DHMPEO).

### Comparative Examples 1-4

### CE1-4

The reaction conditions of each of the comparative examples were similar to those of Example 1, except that comparative example 1 was without the first modifier and that the first modifiers for comparative examples 2-4 were respectively polyethylene glycol 600(PEG600), NPG, and CHDM.

### Comparative Example 5

### CE5

The reaction conditions of comparative example 5 were similar to those of Example 1, except that this comparative example was without the first modifier and that a portion of terephthalic acid was substituted with isophthalic acid (IPA). The mole ratio of terephthalic acid:IPA:ethylene glycol was 1:0.064:1.33.

### Comparative Example 6

### CE6

The reaction conditions of comparative example 6 were similar to those of Example 1, except that this comparative example was without the first modifier and that a portion of terephthalic acid was substituted with adipic acid (AA). The mole ratio of terephthalic acid:AA:ethylene glycol was 1:0.064:1.33.

Examples 1 and 2 and Comparative Examples 1-6 were subjected to the nucleation rate (tan α) and the crystallization rate (G) tests. Table 1 shows the test results for Examples 1 and 2 and Comparative Examples 1-6.

TABLE 1

| | E1 | E2 | CE1 | CE2 | CE3 | CE4 | CE5 | CE6 |
|---|---|---|---|---|---|---|---|---|
| T_{cc}-Tₒₙₛₑₜ ° C. | 20 | 27.6 | 9.1 | 9.0 | 16.6 | 15.8 | 15.0 | 12.6 |
| α, degree | 55 | 38 | 84 | 70 | 60 | 75 | 75 | 80 |
| tan α | 1.41 | 0.78 | 9.51 | 2.74 | 1.73 | 3.73 | 3.73 | 5.67 |
| t_{1/2} min | 4.296 | 5.118 | 1.47 | 1.876 | 3.443 | 4.321 | 4.238 | 3.409 |
| G 1/min | 0.23 | 0.2 | 0.68 | 0.53 | 0.29 | 0.23 | 0.24 | 0.29 |

The results show that Examples 1 and 2 (E1 and E2) have a lower nucleation rate and a lower crystallization rate than those of Comparative Examples (CE1-6).

### Shrinkage Experiments

### Example 3

Terephthalic acid, ethylene glycol, 1,3-dihydroxy-2-methylpropane and 1,1,1,-Tris (hydroxylmethyl)propane in a mole ratio of 1:0.998:0.249:0.003 were uniformly mixed in a container and were formed into a paste. A stabilizer (75 ppm) was added into and blended with the mixture. The paste was fed into an esterification reactor and underwent esterification under a pressure of about 3 kg/cm² for 6 to 7 hours. The reaction temperature reached about 250° C. at the end of the reaction. The mixture was then fed together with a catalyst of a mixture of Sb₂O₃ (300 ppm) and cobalt acetate (50 ppm), into a condensation rector and underwent condensation. The reactor temperature was raised to 285 ° C. and the reactor was vacuumed to about 1 torr in two hours. The condensation was terminated when the intrinsic viscosity of the reaction product reached a range of from 0.7 to 0.9. The duration of the reaction time was about 4 to 5 hours. The product thus formed, having a T_{g} of 70° C., was dried under a temperature of 60° C. for 12 hours, and was fed into an extruder (L/D=32, φ=45, compression ratio=3.0) under a working temperature of from 180 to 215° C. so as to form a PET film. The PET film thus formed was cut into a sheet of 1650 mm in width and 110 mm in thickness, which was thermally stretched 2.7 times of the original length in a transverse direction under a temperature of 78° C. to form the sheet with a thickness of 40 μm. Subsequently, the sheet was bisected in the transverse direction (TD) and then trisected in the machine direction (MD) to obtain six specimens (A-F).

Each specimen was cut into a 100 mm×100 mm piece which was placed in a water bath having a constant temperature of 95° C. for 10 seconds. The heat shrinkage ratio of each specimen was calculated based on the following equation.

Heat Shrinkage Ratio=[(L−l)/L]×100%,

where L represents the length of the stretched specimen before being heated in the water bath and l represents the length of the stretched specimen after being heated in the water bath. Table 2 shows the shrinkage test results for the specimens A-F.

TABLE 2

| | Example 3 | | | | | | | | | | | |
|---|---|---|---|---|---|---|---|---|---|---|---|---|
| | A | | B | | C | | D | | E | | F | |
| shrinkage | MD | TD | MD | TD | MD | TD | MD | TD | MD | TD | MD | TD |
| ratio, % | 4 | 62 | 4 | 62 | 0 | 62 | 1 | 70 | 2 | 69 | 3 | 68 |

The shrinkage test results show that the heat shrinkage ratio of the PET film thus formed can reach 70% in the TD direction and can be less than 4% in the MD direction, which demonstrates a significant improvement in the heat shrinkage property for the PET film made from the modified PET composition of this invention.

### Example 4

The reaction conditions of this example were similar to those of Example 3, except that isophthalic acid (IPA) serving as a second modifier is further included in the modified PET composition. The mole ratio of terephthalic acid, ethylene glycol, 1,3-dihydroxy-2-methylpropane, 1,1,1,-Tris(hydroxylmethyl)propane and isophthalic acid was 1:1.118:0.197:0.003:0.053. The PET film thus formed has a T_{g} of 74° C.

### Example 5

The reaction conditions of this example were the same as those of Example 3. The Melt flow index (MFI) of the reaction product thus formed is about 4 under a testing temperature of about 210° C. and is about 6 under 230° C.

As known in the art, the MFI of a PET material suitable for double bubble blowing is preferably less than 10.

### Comparative Example 7

The reaction conditions of this comparative example were similar to those of Example 3, except that the reaction mixture contained no chain branching agent and that the condensation time was more than 6 hours. The Melt flow index of the reaction product thus formed is about 13 under a testing temperature of about 210° C., and is about 17 under 230° C. Both the Melt flow indexes at the two testing temperatures are higher than the suitable value, i.e., 10, for double bubble blowing.

### Example 6

The reaction conditions of this example were similar to those of Example 3, except for the final process of forming the PET film. After drying under a temperature of 60° C. for 12 hours, the PET product was fed into a blown film extruder (L/D=25, φ=65) having working temperatures of 185, 190 and 195° C. at different locations, a first die operated at 180° C. and a second die operated at 190° C. for subsequent double-bubble blowing operation using a double-bubble blowing apparatus. First, the PET extrudate from the extruder was stretched, and was further stretched by going through double bubble upward film blowing, cooling using air rings. Subsequently, the stretched PET film was wound onto a film take-up roll, followed by passing through three consecutive heating zones in an oven for further stretching. The three heating zones were operated at 110, 100, and 90° C., respectively. The width of the first air ring of the double-bubble blowing apparatus corresponding to the first bubble was about 200 mm, and the width of the second air ring of the double-bubble blowing apparatus corresponding to the second bubble was about 400 mm during the stretching operation.

The heat-shrinkage ratio of the PET film produced from the double bubble blown film extrusion is 15% in one of the MD and TD directions and is 58% in the other of the MD and TD directions based on the standard of JIS Z1709 (under a stretching temperature of 90° C., and a shrinking temperature of 95° C. for 10 seconds).

As illustrated in the shrinkage experiments, the modified PET film of this invention can be stretched by the double bubble blown film extrusion techniques, and its heat shrinkage ratio can reach 70%, which renders the PET material of this invention superior over the aforesaid conventional PET films.

It is noted that although no experiments were made for 2,5-dimethyl-2,5-hexanediol, this compound has asymmetric dimethyl groups and a longer chain length than that of ethylene glycol, wherein can result in a decrease in the nucleation rate and the crystallization rate of the PET polymerization system.

It has thus been shown that, by using 1,3-dihydroxy-2-methylpropane, 1,3-dihydroxy-2-methylpropane alkoxylate, 2,5-dimethyl-2,5-hexanediol, or a combination thereof as the first modifier and by using 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, or combinations thereof as the chain branching agent in the modified PET composition of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A PET material of a modified PET composition comprising:
terephthalic acid;
ethylene glycol;
a first modifier selected from the group consisting of 1,3-dihydroxy-2-methylpropane, 1,3-dihydroxy-2-methylpropane alkoxylate, 2,5-dimethyl-2,5-hexanediol, and combinations thereof; and
a chain branching agent selected from one of a non-cyclic compound and a cyclic compound;
wherein said non-cyclic compound has at least three functional groups;
wherein said cyclic compound, after ring opening, has at least three functional groups; and
wherein each of said functional groups of each of said non-cyclic compound and said cyclic compound is selected from the group consisting of hydroxyl group, carboxyl group, amine group, epoxy group, NCO, and COOR, in which R represents a C₁-C₁₈ alkyl group.

2. The PET material of claim 1, wherein said chain branching agent is selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, and combinations thereof.

3. The PET material of claim 2, wherein said modified PET composition contains 0.01 to 2 mole % of said chain branching agent based on one mole of ethylene glycol.

4. The PET material of claim 3, wherein said modified PET composition contains 0.05 to 1 mole % of said chain branching agent based on one mole of ethylene glycol.

5. The PET material of claim 1, wherein said PET material has a glass transition temperature ranging from 40° C. to 85° C.

6. The PET material of claim 1, wherein said PET material has a melting point ranging from 170° C. to 250° C.

7. The PET material of claim 1, wherein said PET material is amorphous.

8. The PET material of claim 1, wherein said modified PET composition contains 2 to 40 mole % of said first modifier based on one mole of ethylene glycol.

9. The PET material of claim 1, wherein said PET material has an intrinsic viscosity ranging from 0.6 to 1.2.

10. The PET material of claim 1, wherein said modified PET composition further comprises a second modifier selected from the group consisting of a diacid, a diol, and combinations thereof.

11. The PET material of claim 10, wherein said diol is selected from the group consisting of neopentyl glycol, isopentyl diol, polyethylene glycol, bisphenol A alkoxylate, 1,4-cyclohexanedimethanol, and combinations thereof.

12. The PET material of claim 11, wherein said modified PET composition contains 1 to 40 mole % of said diol based on one mole of ethylene glycol.

13. The PET material of claim 10, wherein said diacid is selected from the group consisting of isophthalic acid, sebacid acid, naphthalene dicarboxylic acid, adipic acid, and combinations thereof.

14. The PET material of claim 13, wherein said modified PET composition contains 1 to 30 mole % of said diacid based on one mole of terephthalic acid.

15. A heat shrinkable PET film made from a PET material of a modified PET composition comprising: terephthalic acid; ethylene glycol; a modifier selected from the group consisting of 1,3-dihydroxy-2-methylpropane, 1,3-dihydroxy-2-methylpropane alkoxylate, 2,5-dimethyl-2,5-hexanediol, and combinations thereof; and a chain branching agent selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol and combinations thereof;
wherein said heat shrinkable PET film exhibits a heat-shrinkage ratio greater than 30% in one of MD and TD directions based on the standard of JIS Z1709.

16. The heat shrinkable PET film of claim 15, wherein said shrinkable PET film exhibits a heat-shrinkage ratio greater than 50% in said one of the MD and TD directions and a heat-shrinkage ratio of less than 10% in the other of the MD and TD directions based on the standard of JIS Z1709.

17. A method for making a PET material, comprising:
(a) forming a PET film of a PET material of a modified PET composition that comprises: terephthalic acid; ethylene glycol; a modifier selected from the group consisting of 1,3-dihydroxy-2-methylpropane, 1,3-dihydroxy-2-methylpropane alkoxylate, 2,5-dimethyl-2,5-hexanediol, and combinations thereof; and a chain branching agent selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol and combinations thereof;
(b) thermally stretching the PET film in a stretching direction under a temperature ranging from 50° C. to 130° C. such that the ratio of the film thickness of the PET film after stretching to that of the PET film before stretching ranges from 0.2 to 0.95; and
(c) cooling the thermally stretched PET film.

18. The method of claim 17, wherein formation of the PET film in step (a) is conducted by film blowing techniques.

19. The method of claim 17, wherein the thermally stretching operation in step (b) is conducted by film blowing techniques.

20. The method of claim 17, wherein the thermally stretching operation in step (b) is conducted at a temperature ranging from 70° C. to 95° C.
